(19) United States
(12) Patent Application Publication
(10) Pub. No.: US 2014/0244565 A1
(43) Pub. Date: Aug. 28, 2014

(54) Systems And Methods For Customized Advice Messaging

(71) Applicant: THE PROCTER & GAMBLE COMPANY, Cincinnati, OH (US)

(72) Inventor: Cornelis de Koning, Amsterdam (NL)

(73) Assignee: The Procter & Gamble Company, Cincinnati, OH (US)

(21) Appl. No.: 13/780,128

(22) Filed: Feb. 28, 2013

(51) Int. Cl. G06N 5/02

(52) U.S. Cl. CPC G06N 5/02
USPC 706/50

(57) ABSTRACT

Included are embodiments for customized advice messaging. Some embodiments include registering a patient for receiving customized advice messaging, receiving, via a first electronic message from a message sender, a current question regarding a medical symptom of the patient, and utilizing the patient information to determine whether a previous question has been received that is similar to the current question. In some embodiments, in response to determining that a previous question that is similar to the current question was received, a previous answer to the previous question may be automatically retrieved for answering the current question. The accuracy of the previous answer as a current answer to the current question with a medical expert may be verified, and the previous answer may be sent to the message sender via a second electronic message.

### FIELD OF THE INVENTION

The present application relates generally to systems and methods for customized advice messaging and specifically to receiving medical questions and providing customized answers to those medical questions via electronic messaging.

### BACKGROUND OF THE INVENTION

As pregnant women and new mothers progress through pregnancy and early childhood of their children, they often have questions regarding issues with their bodies, with the body of the unborn child, with the body of the newborn child, and/or other questions. While a general internet search may be utilized to locate answers to such problems, oftentimes the reliability of the information revealed in such searches may be suspect. Additionally, oftentimes, the answers provided are not customized to this particular mother and child. As such, the answers provided to the mother may not be useful, pertinent, or accurate.

### SUMMARY OF THE INVENTION

Included are embodiments for customized advice messaging. Some embodiments include registering a patient for receiving customized advice messaging, receiving, via a first electronic message from a message sender, a current question regarding a medical symptom of the patient, and utilizing the patient information to determine whether a previous question has been received that is similar to the current question. Similarly, in some embodiments, in response to determining that a previous question that is similar to the current question was received, a previous answer to the previous question may be automatically retrieved for answering the current question. The accuracy of the previous answer as a current answer to the current question with a medical expert may be verified, and the previous answer may be sent to the message sender via a second electronic message.

Also included are embodiments of a computing device. Some embodiments of the computing device include a memory component that stores a program to register with a medical establishment, a patient for receiving customized advice messaging. Similarly, in some embodiments, registering the patient includes receiving patient information. The patient information may include background information, physical information, psychological information, and/or medical information about the patient. Additionally, the program may further cause the computing device to receive, via a first electronic message from a message sender, a current question regarding a medical symptom of an unborn child of the patient and utilize the patient information to determine whether a previous question has been received that is similar to the current question. Further, in some embodiments, in response to determining that a previous question that is similar to the current question was received, the program causes the computing device to automatically retrieve a previous answer to the previous question for answering the current question, verify accuracy of the previous answer as a current answer to the current question with a medical expert, and send the previous answer to the message sender via a second electronic message. In response to determining that a previous question is not similar to the current question, the program may cause the computing device to utilize the patient information to automatically determine the current answer to the current question, verify accuracy of the current answer utilizing the medical expert, and send the current answer to the message sender via the second electronic message.

Also included are embodiments of a non-transitory computer-readable medium. Some embodiments of the non-transitory computer-readable medium include a program that causes a computing device to register, with a medical establishment, a patient for receiving customized advice messaging. In some embodiments, registering the patient includes receiving patient information. The patient information may include background information, physical information, psychological information, and/or medical information about the patient. In some embodiments, the program causes the computing device to receive, via a first electronic message from a message sender, a current question regarding a medical symptom of the patient and utilize the patient information to determine whether a previous question has been received that is similar to the current question. Additionally, in response to determining that a previous question that is similar to the current question was received, the program may cause the computing device to automatically retrieve a previous answer to the previous question for answering the current question, verify accuracy of the previous answer as a current answer to the current question with a medical expert, and send the previous answer to the message sender via a second electronic message. In response to determining that a previous question is not similar to the current question, the program may cause the computing device to utilize the patient information to automatically determine the current answer to the current question, verify accuracy of the current answer utilizing the medical expert, store the current question, store the current answer to the current question, and send the current answer to the message sender via the second electronic message, where the medical symptom is related to development of a mother pregnant with a child, the child prior to birth, the child after birth, a menstruating woman, and/or an ovulating woman.

### BRIEF DESCRIPTION OF THE DRAWINGS

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate various embodiments described herein, and together with the description serve to explain the principles and operations of the claimed subject matter.

FIG. 1 depicts a computing environment for providing customized advice messaging, according to embodiments disclosed herein;

FIG. 2 depicts a remote computing device for providing customized advice messaging, according to embodiments disclosed herein;

FIG. 3 depicts a user interface that may be provided to a user for registering with a customized advice messaging service, according to embodiments disclosed herein;

FIG. 4 depicts a user interface that may be provided to a user for entering patient information into a customized advice messaging service, according to embodiments disclosed herein;

FIG. 5 depicts a user interface that may be utilized for selecting service options for a customized advice messaging service, according to embodiments disclosed herein;

FIG. 6 depicts a user interface for indicating contact information for the customized advice messaging service, according to embodiments disclosed herein;

FIG. 7 depicts a flowchart for registering a user with a customized advice messaging service, according to embodiments disclosed herein;

FIG. 8 depicts a flowchart for sending advice to a registered user of a customized advice messaging service, according to embodiments disclosed herein;

FIG. 9 depicts a flowchart for providing customized advice messaging in response to receipt of a question, according to embodiments disclosed herein;

FIG. 10 depicts a flowchart for providing customized advice messaging to a caregiver, according to embodiments disclosed herein; and

FIG. 11 depicts another flowchart for providing customized advice messaging, according to embodiments disclosed herein.

### DETAILED DESCRIPTION OF THE INVENTION

Embodiments disclosed herein include systems and methods for customized advice messaging. Some embodiments are configured to register a patient and/or user related to a patient with a customized advice messaging service at a medical facility. Once registered, the user can receive pieces of advice from the customized advice messaging service via an email, text message, instant message, social media message, and/or other electronic form of communication. Additionally, depending on the particular embodiment, the user may also have an option to register for customized question answering. The customized question answering may receive a question from the registered user. With previously stored patient information, a customized answer to the question may be determined. If necessary, the customized advice messaging service may ask follow-up questions and/or seek the advice of a medical expert (who may ask follow-up questions) to accurately answer the question.

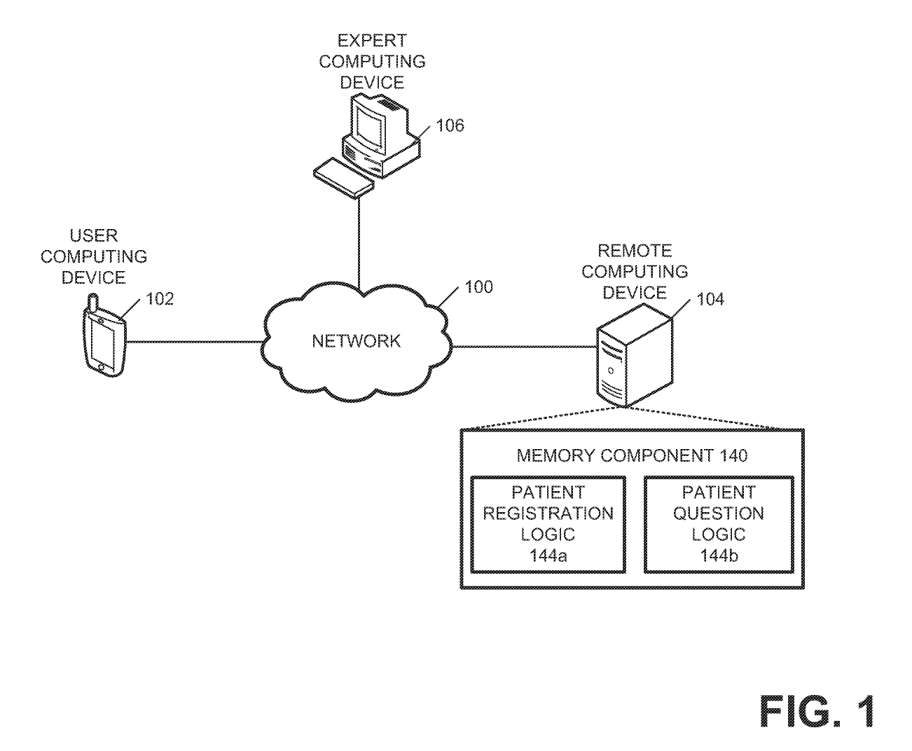

Referring now to the drawings, FIG. 1 depicts a computing environment for providing customized advice messaging, according to embodiments disclosed herein. As illustrated, a network 100 may be coupled to a user computing device 102, a remote computing device 104, and an expert computing device 106. The network 100 may include a wide area network and/or a local area network and thus may be wired and/or wireless. The user computing device 102 may include any portable and/or non-portable computing devices, such as personal computers, laptop computers, personal digital assistants (PDAs), tablet computers, mobile phones, etc. In some embodiments, the user computing device 102 may be configured to send and/or receive data related registration of the customized advice messaging service, as well as send and receive data related to a pregnant woman and/or fetus for answering a question.

Similarly, the remote computing device 104 may be configured as a server and/or other computing device for communicating information with the user computing device 102. As discussed in more detail below, the user computing device 102 may include a memory component 140 that stores patient registration logic 144a and patient question logic 144b (among other pieces of logic). The patient registration logic 144a may include software, hardware, and/or firmware to provide user interfaces for registering a user and/or a patient. As discussed in more detail below, the user may be the mother (an adult relative and/or caregiver) and the patient may be the unborn child or infant child. However, in some embodiments, the patient may be the mother and the user may be the mother, relative, and/or caregiver. Regardless, the patient question logic 144b may include software, hardware, and/or firmware for providing pieces of advice to the user and/or for receiving and answering customized questions from the user. The patient question logic 144b may also be configured to communicate with a medical expert to determine and/or verify an answer, as well as provide related options and functionality described below.

Additionally, the expert computing device 106 may include a personal computer, laptop computer, mobile phone, and/or other computing device and may be accessed by a medical expert. As discussed in more detail below, the remote computing device 104 may send a question and/or answer to the expert computing device 106 to determine and/or verify an answer to the question. The medical expert operating the expert computing device 106 can review the received data and provide feedback to assure accuracy in an answer that will be provided to the user.

It should be understood that while the user computing device 102, the remote computing device 104, and the expert computing device 106 are represented in FIG. 1 each as a single component; this is merely an example. In some embodiments, there may be numerous different components that provide the described functionality. However, for illustration purposes, single components are shown in FIG. 1 and described herein.

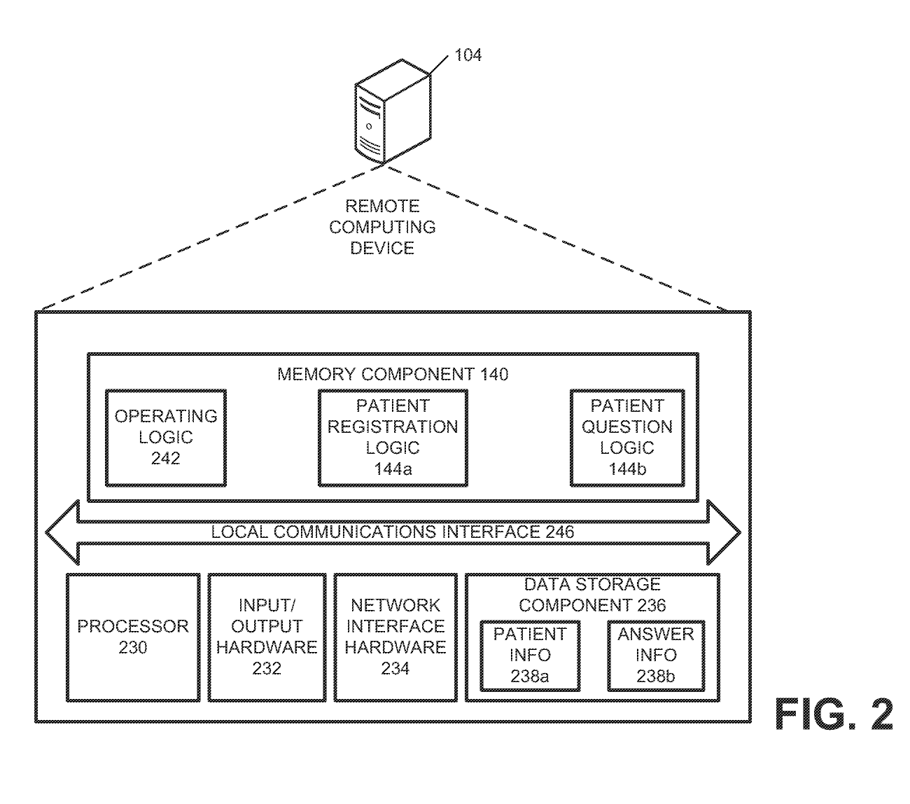

FIG. 2 depicts a remote computing device 104 for providing customized advice messaging, according to embodiments disclosed herein. In the illustrated embodiment, the remote computing device 104 includes a processor 230, input/output hardware 232, network interface hardware 234, a data storage component 236 (which stores patient information 238a, answer information 238b, and/or other data), and the memory component 140. The memory component 140 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the remote computing device 104 and/or external to the remote computing device 104.

Additionally, the memory component 140 may store operating logic 242, the patient registration logic 144a, and the patient question logic 144b. The patient registration logic 144a and the patient question logic 144b may each include a plurality of different pieces of logic, each of which may be embodied as a computer program, firmware, and/or hardware, as an example. A local communication interface 246 is also included in FIG. 2 and may be implemented as a bus or other communication interface to facilitate communication among the components of the remote computing device 104.

The processor 230 may include any processing component operable to receive and execute instructions (such as from the data storage component 236 and/or the memory component 140). The input/output hardware 232 may include and/or be configured to interface with a monitor, positioning system, keyboard, touch screen, mouse, printer, image capture device (such as a still image camera, a video camera, a 2-dimensional camera, 3-dimensional camera, etc.), microphone, speaker, gyroscope, compass, and/or other device for receiving, sending, and/or presenting data. The network interface hardware 234 may include and/or be configured for communicating with any wired or wireless networking hardware, including an antenna, a modem, LAN port, wireless fidelity (Wi-Fi) card, WiMax card, mobile communications hardware, and/or other hardware for communicating with other networks and/or devices. From this connection, communication may be facilitated between the remote computing device 104 and other computing devices.

The operating logic 242 may include an operating system and/or other software for managing components of the remote computing device 104. Similarly, as discussed above, the patient registration logic 144a may reside in the memory component 140 and may be configured to cause the processor 230 to provide user interfaces and register a user with the customized advice messaging service. Similarly, the patient question logic 144b may be utilized to facilitate the answering of questions and providing of pieces of advice. Other functionality is also included and described below.

It should be understood that the components illustrated in FIG. 2 are merely exemplary and are not intended to limit the scope of this disclosure. While the components in FIG. 2 are illustrated as residing within the remote computing device 104, this is merely an example. In some embodiments, one or more of the components may reside external to the remote computing device 104. It should also be understood that, while the remote computing device 104 in FIG. 2 is illustrated as a single device, this is also merely an example. In some embodiments, the patient registration logic 144a and/or the patient question logic 144b may reside on different devices. Additionally, while the remote computing device 104 is illustrated with the patient registration logic 144a and the patient question logic 144b as separate logical components, this is also an example. In some embodiments, a single piece of logic may cause the remote computing device 104 to provide the described functionality.

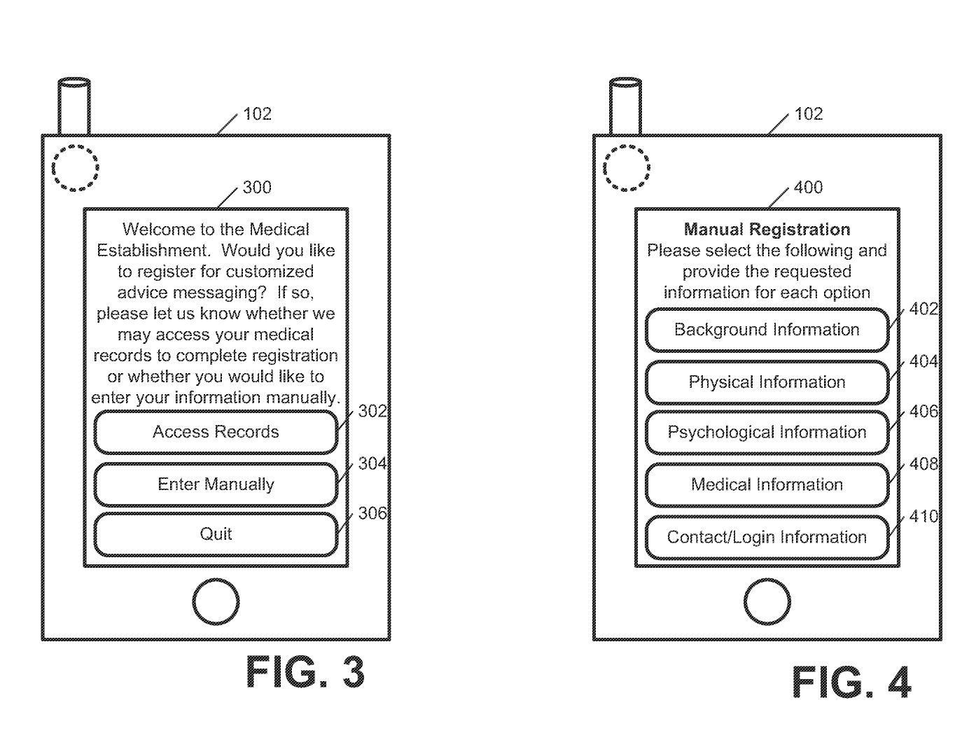

FIG. 3 depicts a user interface 300 that may be provided to a user for registering with a customized advice messaging service, according to embodiments disclosed herein. As illustrated, the user computing device 102 may provide the user interface 300, which may be utilized for registering a user with the customized advice messing service. Depending on the particular embodiment, the user may be the mother of the unborn or recently born child. In some embodiments, the user may be a relative and/or caregiver of the mother, unborn child, or recently born child. Regardless, the user interface 300 may include an access records option 302, an enter manually option 304, and a quit option 306 More specifically, when a user enters a medical establishment, the user computing device 102 can automatically receive and/or provide the user interface 300. However, in some embodiments, the user may log into a website, an intranet site, and/or other portal for providing the user interface 300. In still some embodiments, the information provided in the user interface 300 (and/or user interfaces 400, 500, and 600 from FIGS. 4, 5, and 6, respectively) may be provided via a paper form and then entered into the respective user interface by a technician at the medical establishment.

Regardless, in selecting the access records option 302, the user is authorizing the remote computing device 104 to access patient information for the patient. If the user is the patient, the user may simply verify their identity, and thus authorize the remote computing device 104 to access the patient information. If the user is not the patient, verification may be performed to confirm the user identity, as well as provide an indication that the patient authorizes the access of the patient information. Depending on the particular embodiment, this may be accomplished by sending a message to the patient to indicate the request being made. The message may request authorization of the patient and verify that the patient allows the user access to the patient information. If the patient is a fetus or small child, this may be performed by a parent or legal guardian. In some embodiments, this authorization may be accomplished in person or over a phone call.

Similarly, in response to selection of the enter manually option 304, the user may be prompted to enter the requested information manually, as described with regard to FIG. 4. In response to selection of the quit option 306, the user may exit from the user interface 300.

It should be understood that in some embodiments, in response to selecting the access records option 302, not all of the desired information may be available automatically. In such embodiments, the user computing device 102 may prompt the user for the missing information. Similarly, in some embodiments when the user selects the enter manually option 304, the user may not know all of the requested information. Accordingly, in such embodiments another user option may be provided to automatically search the records for the missing data.

FIG. 4 depicts a user interface 400 that may be provided to a user for entering patient information into a customized advice messaging service, according to embodiments disclosed herein. As illustrated, the user interface 400 may include a plurality of options for providing the patient information. Patient information may include background information, physical information, psychological information, medical information, contact and login information, and/or other relevant data for the patient. Accordingly, the user interface 400 includes a background information option 402, a physical information option 404, a psychological information option 406, a medical information option 408, and a contact/login information option 410.

In response to selection of the background information option 402, the user computing device 102 may request background information of the patient. Background information may include a due date of the child, a length of pregnancy, a doctor name, a scheduled doctor appointment, a previous question asked about the patient, an age of the patient, a sex of the patient, a height of the patient, a weight of the patient, and a prior history of the patient, and/or other general information regarding the patient, unborn child, recently born child, and/or mother. Similarly, in response to selection of the physical information option 404, the user computing device 102 can request the physical information, such as height, weight, age, conception date, gestational cycle dates, due date, and/or other information related to the physical characteristics of the patient. In response to the psychological information option 406, the user computing device 102 may request psychological information regarding the patient, including current emotional state, past emotional states, and/or other relevant psychological data for the patient. In response to selection of the medical information option 408, the user computing device 102 may request medical information, such as allergies, illnesses, surgeries, blood pressure, pulse, cholesterol, blood type, etc. for the mother, unborn child, and/or recently born child.

Additionally, in response to selection of the contact/login information option 410, the user computing device 102 may request a login identifier, password, contact phone number, contact email address, contact social media address, payment information (such as a credit card number, debit card number, etc.) and/or other contact and login information. Once received, not only can the remote computing device 104 utilize the contact information to send outgoing messages, but depending on the particular embodiment, the remote computing device 104 can utilize the contact information to determine whether a received question was sent from a registered user (and if so, which registered user), as described in more detail, below.

It should be understood that in some embodiments, the pregnant woman may be the patient and the user and thus she is interfacing with the user computing device 102 to provide the desired information. Additionally, in some embodiments, the user computing device 102 may also provide a prompt regarding whether any other people may ask questions and/or receive pieces of advice under the registration of the patient. As such, the pregnant woman my designate whether the caregiver or other person has access to medical information and/or other information regarding the pregnant woman.

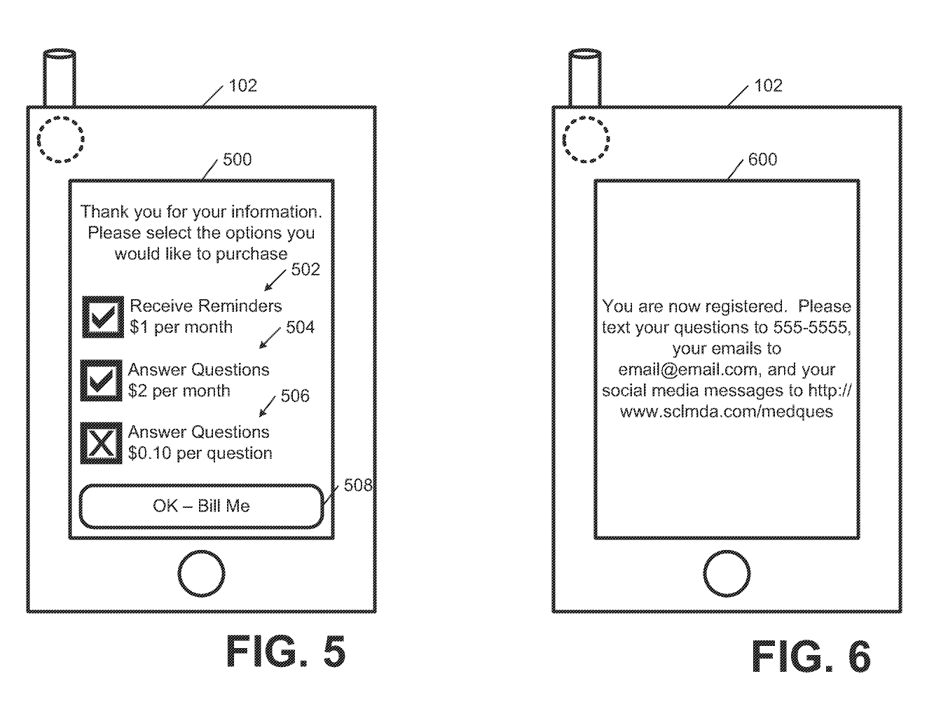

FIG. 5 depicts a user interface 500 that may be utilized for selecting service options for a customized advice messaging service, according to embodiments disclosed herein. As illustrated, the user interface 500 includes a plurality of options regarding the services the user desires. More specifically, in response to entering the requested information from the user interface 400 (FIG. 4) and/or automatically submitting the requested information from the user interface 300 (FIG. 3), the user interface 500 may be provided and include a reminders option 502, a monthly questions option 504, and a per question option 506. In response to selection of the reminders option 502, the remote computing device 104 may send one or more pieces of advice to the user. The pieces of advice may be sent upon a determination that an event is approaching (such as a doctor's appointment, the end of a trimester, etc.) and/or at other times.

The pieces of advice may remind the user of the appointment, may provide relevant advice to the user based on the patient information received, provide product recommendations, product advertisements, promotions, and/or otherwise provide helpful advice to the user, based on the determined stage of development. The product recommendations may include recommendations for a product that is related to a question and/or current answer (described below), a service that is related to the current answer, medical literature that is related to the current answer, and literature for a health care provider visit. In response to selection of the monthly questions option 504, the user may provide questions to the remote computing device 104, which can process the questions and provide a customized answer, based on the patient information. Accordingly, the monthly questions option 504 may be configured to bill the user on a monthly basis, regardless of the number of questions, while the per question option 506 may be configured to bill the user for each question asked. Once the desired selections are made, the user may select a bill me option 508 for completing the registration process. The service provided may be automatically provided and billed to the payment information provided by the user.

FIG. 6 depicts a user interface 600 for indicating contact information for the customized advice messaging service, according to embodiments disclosed herein. As illustrated, in response to completing the registration process, the user interface 600 may indicate the text messaging number, email address, social media address, etc. to which the user can send questions to be answered. Other information may also be provided, depending on the particular configuration.

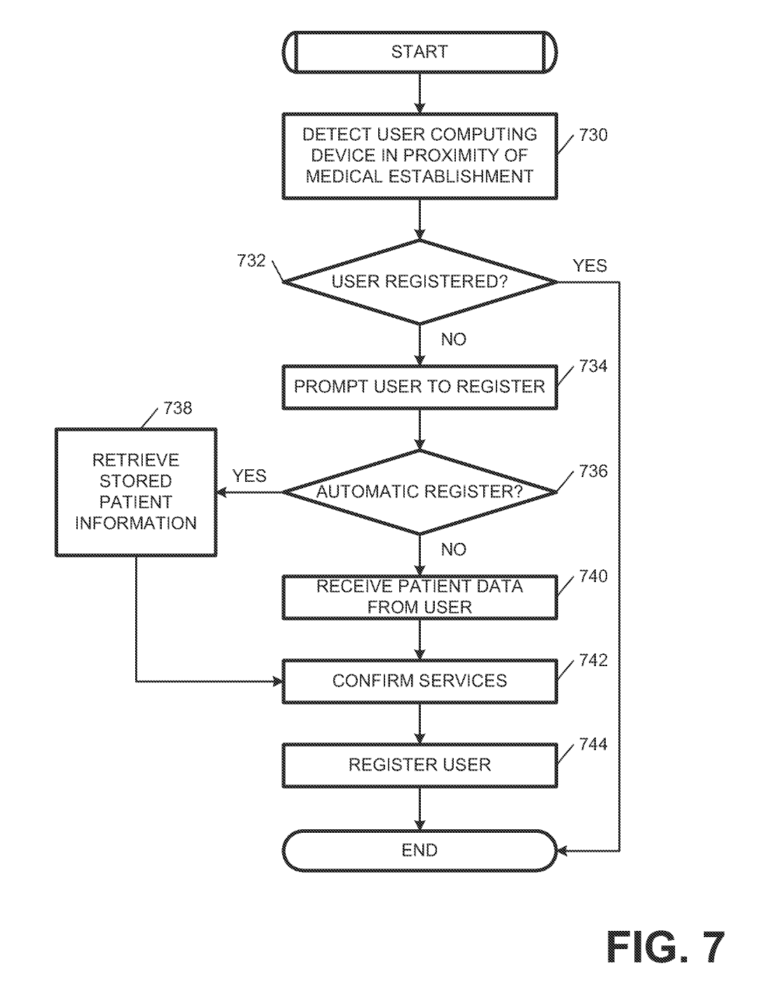

FIG. 7 depicts a flowchart for registering a user with a customized advice messaging service, according to embodiments disclosed herein. As illustrated in block 730, a user computing device 102 may be detected as being in the proximity of a medical establishment. The user medical establishment may include a hospital, clinic, doctor's office, and/or other facility for providing medical services. In block 732, a determination may be made regarding whether the user is registered. If the user is already registered, the process may end. If the user is not yet registered, in block 734, the user may be prompted to register. In block 736, a determination may be made regarding whether the user will utilize automatic registration by allowing the medical establishment to access the stored medical records to determine the patient information. If so, in block 738, the stored patient information may be retrieved. However, if the user desires manual registration, the user may enter the patient information manually and thus, in block 740, the patient information may be received from the user. In block 742, the desired services may be confirmed. In block 744, the user may be registered.

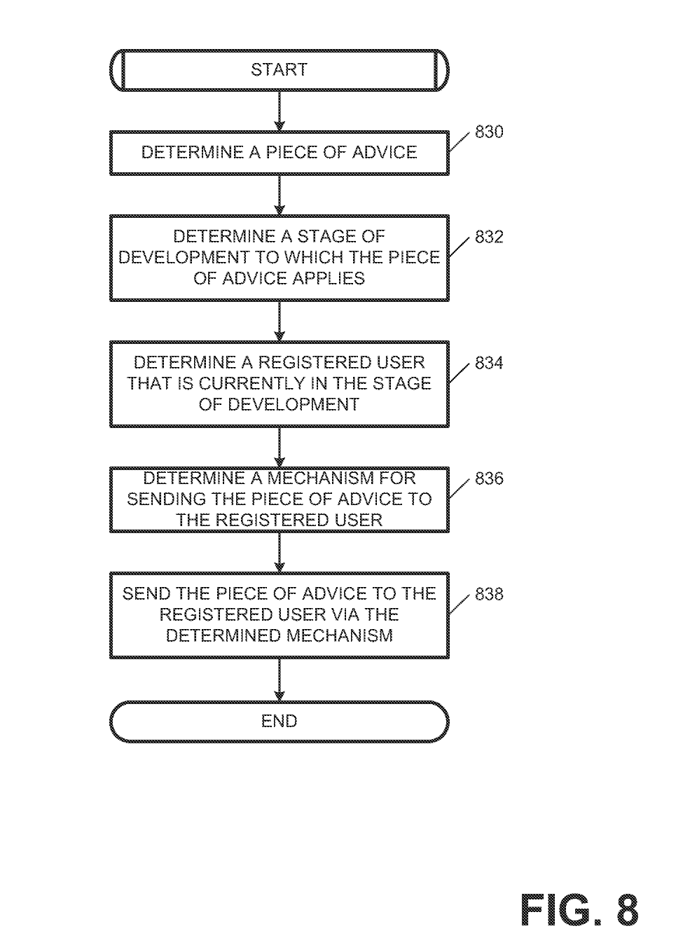

FIG. 8 depicts a flowchart for sending advice to a registered user of a customized advice messaging service, according to embodiments disclosed herein. As illustrated in block 830, a piece of advice may be determined. As discussed above, the piece of advice may be a doctor appointment reminder, a general piece of advice, etc. Regardless, in block 832, a stage of development to which the piece of advice applies may be determined. In block 834, a registered user that is currently in that stage of development may be determined. In block 836, a determination may be made regarding a mechanism for sending the piece of advice to the registered user (e.g., text message, email, social media, etc.). As discussed above, this may depend on the contact information provided by the user during registration. In block 838, the piece of advice may be sent to the registered user via the determined mechanism.

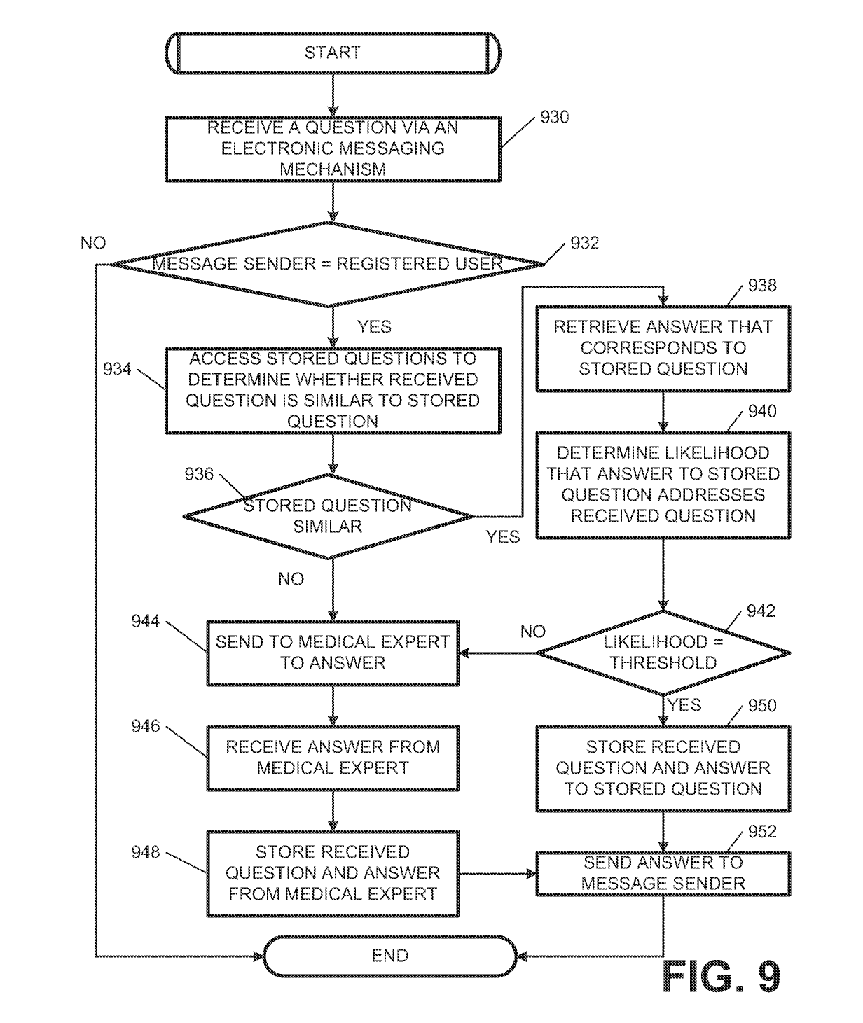

FIG. 9 depicts a flowchart for providing customized advice messaging in response to receipt of a question, according to embodiments disclosed herein. In block 930, a question may be received via an electronic messaging mechanism. In block 932, a determination may be made regarding whether the message sender is a registered user. If not, the process may end. If the message sender is a registered user, in block 934, stored questions may be accessed to determine whether the received question is similar to a stored question. More specifically, in some embodiments, a word comparison may be made between the received question and stored questions. Similarly, in some embodiments, the patient information may be utilized and compared with patient information associated with the stored question. Regardless, in block 936, a determination may then be made regarding whether current question is similar to the previous (stored) question. If a stored question is similar to the received question, in block 938, an answer that corresponds to the stored question may be retrieved. In block 940, a determination may then be made regarding the likelihood that the retrieved answer to the stored question addresses the received question. Accordingly, in block 942 a determination may be made regarding whether the likelihood meets a predetermined accuracy threshold. If the threshold is not met, the process may proceed to block 944. In block 944 (from block 936 or block 942), the question, answer, and at least a portion of the patient information may be sent to a medical expert. In block 946, an answer may be received from the medical expert. In block 948, the received question and answer from the medical expert may be stored.

If in block 942, the likelihood does meet the threshold, in block 950, the received question and the answer to the stored question may be stored. In block 952 (from block 950 or 948), the answer may be sent to message sender.

It should be understood that in some embodiments, even if the current question is not similar to a stored question, the remote computing device 104 may determine an answer to the current question. More specifically, the remote computing device 104 may be configured to access medical journals, and/or other supplemental medical documents. If at that point, an answer is still not determined to a desired accuracy confidence, the question, patient information, etc. may be sent to the medical expert. Additionally, in some embodiments, the remote computing device 104 (and/or medical expert) may ask a follow-up question to more fully understand the characteristics of the question being asked. Similarly, in some embodiments, the user computing device 102 may include an image capture device, and audio capture device, etc. With these components, still images, video images, audio segments, etc. may be sent to the remote computing device 104 to supplement the question being asked.

It should also be understood that in some embodiments, in response to determining that the message sender is not a registered user, the remote computing device 104 can determine an answer to the question without the use of the patient information. More specifically, if a user has access to the patient's account, but not to the patient information (or if the patent has not provided any patient information), the user may ask a question that may be answered, but is not customized to the patient.

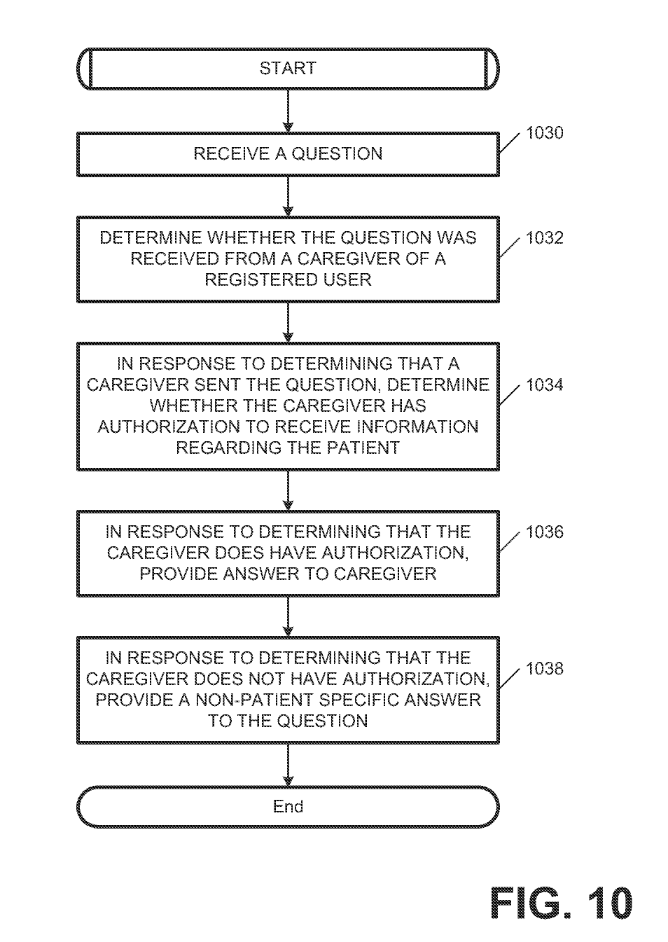

FIG. 10 depicts a flowchart for providing customized advice messaging to a caregiver, according to embodiments disclosed herein. As illustrated in block 1030, a question may be received. In block 1032, a determination may be made regarding whether the question was received from a caregiver of a patient. In block 1034, in response to determining that the question originated from a caregiver, a determination may be made regarding whether the caregiver has authorization to receive information related to the patient. In block 1036, in response to determining that the caregiver does have authorization, the answer may be provided to the caregiver. In block 1038, in response to determining that the caregiver does not have authorization, a non-patient specific answer may be provided to the current question.

More specifically, if the caregiver does not have authorization to view information for the patient, the remote computing device 104 may determine an answer to the caregiver question, without accessing confidential patient information of the patient. If however, the patient has indicated a medical symptom, physical condition, emotional condition, etc. that would be evident to others (such as approximate height, approximate age, late stage pregnancy, etc.), this information may be utilized to answer the question. However, any patient information that is confidential would not be utilized to answer the question.

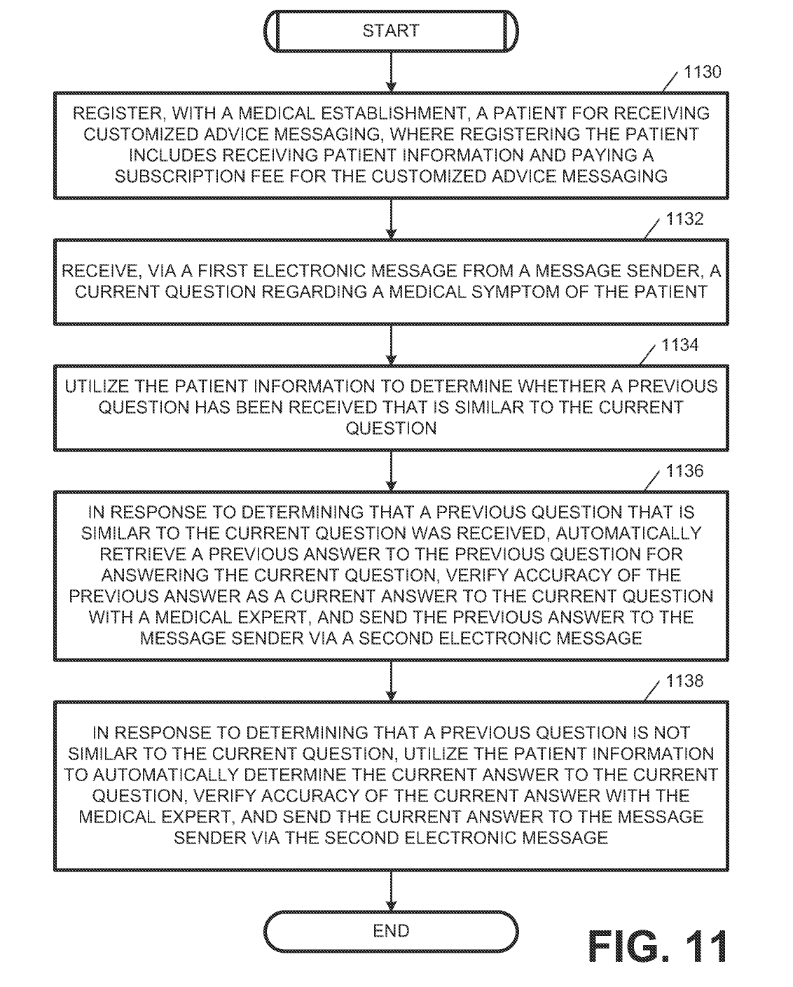

FIG. 11 depicts another flowchart for providing customized advice messaging, according to embodiments disclosed herein. As illustrated in block 1130, a patient may be registered with a medical establishment for receiving customized advice messaging. In some embodiments, registering the patient includes receiving patient information and paying a subscription fee for the customized advice messaging. In block 1132, a first electronic message may be received from a message sender. The first electronic message may include a current question regarding a medical symptom of the patient. In block 1134, the patient information may be utilized to determine whether a previous question has been received that is similar to the current question. In block 1136, in response to determining that a previous question that is similar to the current question was received, a previous answer to the previous question may be automatically retrieved for answering the current question. Additionally, the accuracy of the previous answer as a current answer to the current question may be verified with a medical expert. Additionally, the previous answer may be sent to the message sender via a second electronic message. In block 1138, in response to determining that a previous question is not similar to the current question, the patient information may be utilized to automatically determine the current answer to the current question. Additionally, the accuracy of the current answer may be verified with the medical expert. The current answer may additionally be sent to the message sender via the second electronic message.

It should also be understood that in some embodiments, the user may send a question that causes the remote computing device 104 to trigger an alert. More specifically, if the user submits a medical question that, based on the patient information, could be a serious emergency medical condition, the remote computing device 104 may automatically alert the user, an emergency medical technician, doctor, medical expert, caregiver, and/or other relevant party immediately. As an example, if the user sends a question that indicates certain symptoms and the remote computing device 104 identifies a harmful combination of prescription medications that the patient is taking, the remote computing device 104 can determine that the patient may be experiencing a serious reaction to the medications. Accordingly, the remote computing device 104 may immediately alert poison control, contact an ambulance, indicate the situation to the user, and/or perform other emergency medical procedures.

Similarly, in some embodiments, the remote computing device 104 may be configured to receive a designated emergency message from the user (such as a “911 text”) to respond to a medical emergency. Because the remote computing device 104 has access to the patient information, at least a portion of the patient information and/or a preliminary medical analysis may be made and sent to the emergency medical technician prior to reaching the patient.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be understood to those skilled in the art that various other changes and modifications can be made without departing from the spirit and scope of the invention. It is therefore intended to cover in the appended claims all such changes and modifications that are within the scope of this invention.

What is claimed is:

1. A method for customized advice messaging, comprising:
registering a patient for receiving customized advice messaging, wherein registering the patient comprises receiving and storing patient information, wherein the patient information comprises at least one of the following: background information and physical information about the patient;
receiving, via a first electronic message from a message sender, a current question regarding a medical symptom of the patient;
utilizing the patient information to determine whether a previous question has been received that is similar to the current question;
in response to determining that a previous question that is similar to the current question was received, automatically retrieving a previous answer to the previous question for answering the current question, and sending the previous answer to the message sender via a second electronic message; and
in response to determining that a previous question is not similar to the current question, utilizing the patient information to automatically determine the current answer to the current question, verifying accuracy of the current answer with the medical expert, and sending the current answer to the message sender via the second electronic message,
wherein the medical symptom is related to development of at least one of the following: a mother pregnant with a child, the child prior to birth, the child after birth, a menstruating woman, and an ovulating woman.

2. The method of claim 1, wherein the patient information further comprises at least one of psychological information and medical information about the patient.

3. The method of claim 1, further comprising, in response to receiving the current question regarding the medical symptom of the patient, sending a follow-up question regarding the medical symptom to the message sender.

4. The method of claim 1, the message sender comprises at least one of the following: the patient, an adult relative of the patient, and a caregiver of the child.

5. The method of claim 1, wherein the background information comprises at least one of the following: a due date of the child, a length of pregnancy, a doctor name, a scheduled doctor appointment, a previous question asked about the patient, an age of the patient, a sex of the patient, a height of the patient, a weight of the patient, and a prior medical history of the patient.

6. The method of claim 1, further comprising sending a promotion for at least one of the following: a product that is related to the current answer, a service that is related to the current answer, medical literature that is related to the current answer, and literature for a health care provider visit.

7. The method of claim 1, wherein verifying accuracy of the current answer utilizing the medical expert comprises sending the current question and the current answer to a computing device of the medical expert and receiving, via the computing device of the medical expert, a verification that the current answer is accurate.

8. The method of claim 1, wherein determining the current answer comprises at least one of the following: automatically determining the current answer from a supplemental medical document and sending the current question to the medical expert.

9. A computing device for customized advice messaging, comprising:
a memory component that stores a program for performing at least the following:
register a patient for receiving customized advice messaging, wherein registering the patient comprises receiving and storing patient information, wherein the patient information comprises at least one of the following: background information and physical information about the patient;
receive, via a first electronic message from a message sender, a current question regarding a medical symptom of an unborn child of the patient;
utilize the patient information to determine whether a previous question has been received that is similar to the current question;
in response to determining that a previous question that is similar to the current question was received, automatically retrieve a previous answer to the previous question for answering the current question, and send the previous answer to the message sender via a second electronic message; and
in response to determining that a previous question is not similar to the current question, utilize the patient information to automatically determine the current answer to the current question, verify accuracy of the current answer utilizing the medical expert, and send the current answer to the message sender via the second electronic message.

10. The method of claim 9, wherein the patient information further comprises at least one of psychological information and medical information about the patient.

11. The computing device of claim 9, wherein the medical information comprises at least one of the following: a due date of the unborn child, a length of pregnancy, a doctor name, a scheduled doctor appointment, a previous question asked about the patient, an age of the patient, a sex of the patient, a height of the patient, a weight of the patient, and a prior medical history of the patient.

12. The computing device of claim 9, wherein the program further causes the computing device to send a promotion for at least one of the following: a product that is related to the current answer, a service that is related to the current answer, medical literature that is related to the current answer, and literature for a health care provider visit.

13. The computing device of claim 9, wherein determining the current answer comprises at least one of the following: automatically determining the current answer from a supplemental medical document and sending the current question to the medical expert.

14. The computing device of claim 9, wherein the program causes the computing device to store the current question and the current answer to the current question, in response to determining the current answer to the current question.

15. The computing device of claim 9, wherein the current question is received from at least one of the following: the patient and a caregiver, and wherein in response to the current question being received from the caregiver, the program causes the computing device to perform at least the following:
determine whether the caregiver has authorization to receive information regarding the patient;
provide the current answer in response to determining that the caregiver has authorization to receive information regarding the patient; and
provide a non-patient specific answer to the current question, in response to determining that the caregiver does not have authorization to receive information regarding the patient.

16. A non-transitory computer-readable medium for customized advice messaging that stores a program causes a computing device to perform the following:
register a patient for receiving customized advice messaging, wherein registering the patient comprises receiving and storing patient information, wherein the patient information comprises at least one of the following: background information and physical information about the patient;
receive, via a first electronic message from a message sender, a current question regarding a medical symptom of the patient;
utilize the patient information to determine whether a previous question has been received that is similar to the current question;
in response to determining that a previous question that is similar to the current question was received, automatically retrieve a previous answer to the previous question for answering the current question, and send the previous answer to the message sender via a second electronic message; and
in response to determining that a previous question is not similar to the current question, utilize the patient information to automatically determine the current answer to the current question, verify accuracy of the current answer utilizing the medical expert, store the current question, store the current answer to the current question, and send the current answer to the message sender via the second electronic message,
wherein the medical symptom is related to development of at least one of the following: a mother pregnant with a child, the child prior to birth, the child after birth, a menstruating woman, and an ovulating woman.

17. The method of claim 16, wherein the patient information further comprises at least one of psychological information and medical information about the patient.

18. The non-transitory computer-readable medium of claim 16, wherein the medical information comprises at least one of the following: a due date of the child prior to birth, a length of pregnancy, a doctor name, a scheduled doctor appointment, a previous question asked about the patient, an age of the patient, a sex of the patient, a height of the patient, a weight of the patient, and a prior medical history of the patient.

19. The non-transitory computer-readable medium of claim 16, wherein the program further causes the computing device to send a promotion for at least one of the following: a product that is related to the current answer, a service that is related to the current answer, medical literature that is related to the current answer, and literature for a health care provider visit.

20. The non-transitory computer-readable medium of claim 16, wherein determining the current answer comprises at least one of the following: automatically determining the current answer from a supplemental medical document and sending the current question to the medical expert.

21. The non-transitory computer-readable medium of claim 16, wherein the current question is received from at least one of the following: the patient and a caregiver.

22. The non-transitory computer-readable medium of claim 16, wherein in response to the current question being received from the caregiver, the program causes the computing device to perform at least the following:
determine whether the caregiver has authorization to receive information regarding the patient;
provide the current answer to the current question in response to determining that the caregiver has authorization to receive information regarding the patient; and
provide a non-patient specific answer to the current question, in response to determining that the caregiver does not have authorization to receive information regarding the patient.

23. The non-transitory computer-readable medium of claim 16, wherein the patient is registered by at least one of the following: the patient and a caregiver.
